(19) United States
(12) Patent Application Publication
(10) Pub. No.: US 2004/0083441 A1
(43) Pub. Date: Apr. 29, 2004

(54) Method of generating net-list for designing integrated circuit device

(75) Inventors: Yong-Hoon Gweon, Yongin-City (KR); Jin-Yong Lee, Seoul (KR); Yong-Kwan Kim, Seoul (KR); Hyun-Sik Park, Seoul (KR); Hye-Kyong Song, Bucheon-City (KR)

Correspondence Address: F. Chau & Associates, LLP, Suite 501, 1900 Hempstead Turnpike, East Meadow, NY, 11554, US

(73) Assignee: Samsung Electronics Co., Ltd.

(21) Appl. No.: 10/440,678

(22) Filed: May 19, 2003

(30) Foreign Application Priority Data
Oct. 24, 2002 (KR) 2002-65247

(51) Int. Cl. G06F 17/50

(52) U.S. Cl. 716/12

(57) ABSTRACT

A method of generating a net-list for designing an integrated circuit device is provided, including generating a pin template file by laying out logic elements included in the integrated circuit device, generating a pin file by assigning a serial number to the logic elements and setting power names necessary for operating the logic elements, and generating a power inform template file by grouping an internal circuit of the integrated circuit device by a unit of power, generating a power inform file by combining the pin file with the power inform template file and arranging power information which is separately applied to each logic element, generating a final power inform file by assigning correct power names to power ports, to which power applied thereto is not defined, and completing a final net-list by combining core-related information of the integrated circuit device with the final power inform file.

This application claims priority to Korean Patent Application No. 2002-65247, filed on Oct. 24, 2002, in the Korean Intellectual Property Office.

### BACKGROUND OF THE INVENTION

1. Field of the Invention

The present invention relates generally to a method for generating a net-list for an integrated circuit device design, and more particularly, to a method for generating a net-list for designing a system-on-chip which includes a plurality of power sources.

2. Description of the Related Art

In general, an integrated circuit device is designed by following five steps.

(1) Determining a system specification;

(2) Designing a schematic for performing functions related to the system specification;

(3) Generating a net-list;

(4) Placing and routing a layout, and Verifying layout vs. schematic (LVS); and

(5) Preparing a mask.

The present invention relates particularly to the third step, i.e., generating a net-list. The net-list is a combination of nets, e.g., networks, that connects logic elements, such as a NAND gate, an OR gate, or the like to define a layout for an integrated circuit.

In a conventional net-list, a power net includes only definitions of a supply voltage as VDD and a ground voltage as VSS and does not include various other definitions like those of a signal net. Although various types of important properties (IPs), such as analog IPs, and various power sources having the same design are used in integrated circuit device design, a physical design resulting from dividing and supplying various power sources to various IPs can not be automatically generated and, thus, such a physical design can not be verified. In the conventional art, edtext names are manually added to the net-list to guarantee division of various power sources of an applied IP, a subcircuit, and a primary pin. However, it is nearly impossible to manually divide power sources among large scale and complex digital logic.

Since the edtext names are added manually, verification of the physical design takes a considerable amount of time. In addition, when a database for verification of the division of power sources is corrected manually, there is an increased chance of error, thus performance and reliability characteristics are degraded.

A need therefore exists for a method for generating a net-list for designing an integrated circuit device having a plurality of power sources so as to apply a separate power to each logic element.

### SUMMARY OF THE INVENTION

In one aspect of the present invention, a method for generating a net-list for designing an integrated circuit device is provided comprising generating a pin template file by laying out logic elements included in an input/output unit of the integrated circuit device, generating a pin file by assigning a serial number to the logic elements and setting power names necessary for operating the logic elements, and generating a power inform template file by grouping an internal circuit of the integrated circuit device by a unit of power, generating a power inform file by combining the pin file with the power inform template file and arranging power information which is separately applied to each logic element included in the grouped internal circuit, generating a final power inform file by assigning correct power names to power ports, to which power applied thereto is not defined, in the power inform file, and completing a final net-list by combining core-related information of the integrated circuit device with the final power inform file.

In another aspect of the present invention, a method for generating a net-list for designing an integrate circuit device is provided comprising generating an initial net-list in which power is not included, converting the initial net-list into a pin template file in which logic elements included in the input/output unit of the integrated circuit device are laid out by using a conversion program, generating a pin file by editing the pin template file to assign a serial number to the logic elements and setting power names necessary for operating the logic elements, and generating a power inform template file by grouping an internal circuit of the integrated circuit device by a unit of power, generating a power inform file in which power information, which is separately applied to each logic element included in the grouped internal circuit, is arranged from the pin file and the power inform template file by using the conversion program, generating a final power inform file by editing the power inform file and assigning correct power names to power ports, to which power applied thereto is not defined, in the power inform file, and generating a final net-list including core-related information of the integrated circuit device in the final power inform file by using the conversion program.

According to embodiments of the present invention, the reliability of placing and routing and verifying a layout are improved.

### BRIEF DESCRIPTION OF THE DRAWINGS

The above aspects of the present invention will become more apparent by describing in detail preferred embodiments thereof with reference to the attached drawings in which:

FIG. 1 is a block diagram of an integrated circuit device usable for generating a net-list for designing an integrated circuit device according to an embodiment of the present invention; and

FIG. 2 is a flowchart of a method for generating a net-list for designing an integrated circuit device according to an embodiment of the present invention.

### DETAILED DESCRIPTION OF PREFERRED EMBODIMENTS

The present invention will now be described more fully with reference to the accompanying drawings, in which preferred embodiments of the invention are shown.

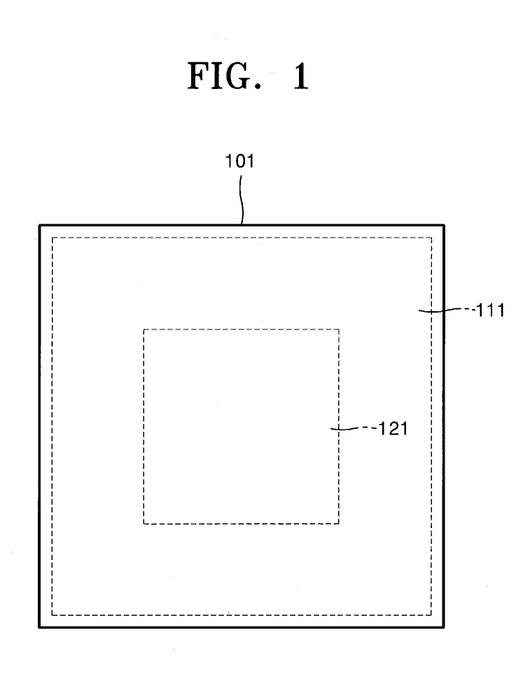

FIG. 1 is a block diagram of an integrated circuit device for explaining a method for generating a net-list for designing an integrated circuit device according to an embodiment of the present invention. Referring to FIG. 1, an internal circuit of an integrated circuit device 101 is comprised of an input/output unit 111 and a core unit 121.

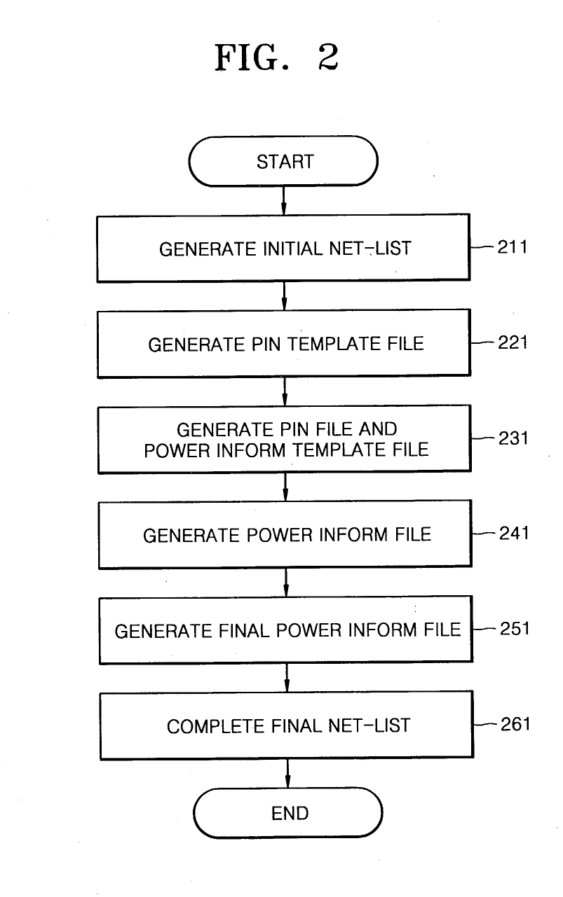

FIG. 2 is a flowchart of a method for generating a net-list for designing an integrated circuit device according to an embodiment of the present invention. A method for generating a net-list will be described with reference to FIG. 1 and FIG. 2.

In a first step 211, an initial net-list, which does not have a definition of power, is generated. The initial net-list can be generated by a customer who places an order for designing the integrated circuit device, e.g., an application specific integrated circuit (ASIC).

In a second step 221, the initial net-list is converted by using a conversion program, e.g., cubicware, into a pin template file where logic elements included in the input/output unit 111 of the integrated circuit device 101 are arranged. The second step 211 is performed in a processing system where the conversion program is installed. Table 1 shows an embodiment of the pin template file. Referring to Table 1, there are names of instances vdd01 and vdd02 in a logic element, or cell_name, vdd3i and the power names VDD3I of the instances vdd01 and vdd02 are the same.

TABLE 1

| pin_num | pin_name | pin_type | instance_name | cell_name |
|---|---|---|---|---|
| * | ALE | I | pad01 | pic |
| * | VDD3I | P | vdd01 | vdd3i |
| * | VDD3I | P | vdd02 | vdd3i |
| * | VSST | G | vss01 | vsst |

In a third step 231, the pin template file is edited to assign serial numbers to the logic elements, and a pin file is generated by setting a power name necessary for operating the logic elements. An internal circuit of the integrated circuit device 101 is grouped by a unit of power to generate a power inform template file. Tables 2 and 3 show examples of the pin file and the power inform template file, respectively.

TABLE 2

| pin_num | pin_name | pin_type | instance_name | cell_name |
|---|---|---|---|---|
| 11 | ALE | I | pad01 | pic |
| 12 | VDD3IA | P | vdd01 | vdd3i |
| 13 | VDD3IB | P | vdd02 | vdd3i |
| 14 | VSST | G | vss01 | vsst |

Referring to Table 2, a pin number is assigned to each logic element and power names (e.g., VDD3IA, VDD3IB, or the like) of each instance (e.g., vdd01, vdd02, or the like) are differentiated from one another. The power names (VDD3IA, VDD3IB, or the like) are determined by a designer of the integrated circuit device 101.

TABLE 3

# power information template file
group analog_block {

vdd01 ; anal_01 ; vss01 ;

}
group digital_block {

core ; vdd02 ; vss01 ;

}

Referring to Table 3, at least one power pad (e.g., vdd01/vss01, vdd02/vss01) is written in each power group (e.g., analog_block, digital_block).

In a fourth step 241, a power inform file in which power information, which is applied to each logic element included in the power group, is arranged is generated. The power inform file is generated from the pin file and the power inform template file by using the conversion program. That is, the power inform template file is read by the conversion program, e.g., cubicware, to indicate a port name and an expected power name. Table 4 shows an example of the power inform file. Referring to Table 4, the power names defined in the pin file are written in the powers of the power groups (e.g., analog_block, digital_block). If the power, which is applied to the power ports of the power inform file, is not defined, a question mark is generated so that the designer can assign a correct power name to such power ports.

TABLE 4

| | |
|---|---|
| // | power information file generated by Cubicware |
| // | power planning info . . . (for documentation) |

| | |
|---|---|
| // | power_groups (2) : anlog_block, digital_block |

| | |
|---|---|
| // | analog_block (3) : vdd01(vdd3i), anal_01(PLL), vss01(vsst) |
| // | digital_block (3) : vdd02(vdd3i), core (ARM7T), vss01 (vsst) |

group analog_block

/ * used power net * /
VDD3IA VDD3O VDD3I VSST
{

| | |
|---|---|
| vdd01 | VDD3I=VDD3IA ; // cell_name:vdd3i |
| vss01 | VSST ; cell_name : vsst |
| anal_01 | VPAD1=? VPAD2=? GND=?; // cell_name : PLL |

}

group digital_block

/ * used power net * /

VDD3IB VDD3O VDD3I VSST
{

| | |
|---|---|
| vdd01 | VDD3I=VDD3IB ; // cell_name:vdd3 |
| vss01 | VSST=VSST ; // cell_name : vsst |
| core | VPAD=? GPAD2=? ; // cell_name : ARM7T |

In a fifth step (251), the power inform file is edited to assign correct power names to the power ports in which the power applied is not defined, so that a final power inform file is generated. Table 5 shows an example of the final power inform file.

TABLE 5

| | |
|---|---|
| // | power information file generated by Cubicware |
| // | power planning info . . . (for documentation) |

| | |
|---|---|
| // | power_groups (2) : anlog_block, digital_block |

| | |
|---|---|
| // | analog_block (3) : vdd01(vdd3i), anal_01(PLL), vss01(vsst) |
| // | digital_block (3) : vdd02(vdd3i), core (ARM7T), vss01 (vsst) |

group analog_block

/ * used power net * /
VDD3IA VDD3O VDD3I VSST
{

| | |
|---|---|
| vdd01 | VDD3I=VDD3IA ; // cell_name:vdd3i |
| vss01 | VSST ; cell_name : vsst |
| anal_01 | VPAD1=VDD3IA VPAD2=VDD3IA GND=VSST; // cell_name : PLL |

}

group digital_block

/ * used power net * /

VDD3IB VDD3O VDD3I VSST
{

| | |
|---|---|
| vdd01 | VDD3I=VDD3IB ; // cell_name:vdd3 |
| vss01 | VSST=VSST ; // cell_name : vsst |
| core | VPAD=? GPAD2=? ; // cell_name : ARM7T |

In a sixth step (261), a final net-list is generated by using the conversion program. The final net-list includes information on a core unit 121 of the integrated circuit device 101 from the final power inform file. Table 6 shows an example of the final net-list.

TABLE 6
// DESIGN : CIP4
module CIP4 (nRESET, XP, TM, NTEST, TEST1, TEST2, nCS, nWR, XDACK1, XDACK2,

| | |
|---|---|
| | SRAM_A6, SRAM_A5, SRAM_A4, SRAM_A3, SRAM_A2, SRAM_A1, SRAM_A0, |
| | SRAM_nWR, SDIO2); |
| Input | nRESET, XP, TM, NTEST, TEST1, TEST2, nCS, nRD, nWR, XDACK1, XDACK2, |
| | XDACK3, AFE_D6, AFE_D5, AFE_D4, AFE_D3, AFE_D2, AFE_D1, AFE_D0, |
| | RTC_X1; |
| output | XPOUT, CLK_OUT, XDREQ1, XDREQ2, XDREQ3, IRQ, SRAM_A15, SRAM_A14, |
| | SRAM_A13, SRAM_A12, SRAM_A11, SRAM_A10, SRAM_A9, SRAM_A8, |
| | SRAM_A7, SRAM_A6, GPO2, GPO1, RTC_XO; |
| supply 1 | VDD3OP ; |
| supply 1 | VSS3 OP ; |
| supply 0 | VSS3 OP ; |
| supply 0 | PLL-VBB ; |
| supply 1 | PLL-VDD ; |
| supply 1 | PLL-ANALOG_VDD ; |
| supply 0 | PLL-VSS |
| supply 0 | PLL-ANALOG_VSS ; |
| supply 1 | RTC-VDD |
| supply 0 | RTC-VSS ; |
| wire | [symbol] Inst_CIP4MAIN/A1_CIP4TOP/MEMSEL_BIST3_2A, iADC_DATA_2A, |
| | iADC_DATA_7A, |
| | [symbol] Inst_CIP4MAIN/A1_CIP4TOP/A5_JBIGTOP/D1Inst_JENC_CORE/fifoFul, |

| | |
|---|---|
| phsoscm26 | Inst1_PSOSC(.PADA(XP), .E(VDD2I), .PI(NET08),.PADY(XPOUT), |
| | .YN(CLK_SYS),.PO(NET 09),.VDD3O(VDD3OP),.VDD2I(VDD2I), |
| | .VSSO(VSS3OP), .VSSP(VSS3OP)); |

nid16 ecoInst_ft14(.A(n51807),. Y(ecoNet_ft14),. VDD(VDD2I), .VSS2I));
ivd6 U98(.A(ecoNet_ft34),. Y(n51956),.VDD(VDD2I),.VSS(VSS2I));
vdd3op VDD3OP2(.CDL(CDL0),.VSSO(VSS3OP), .VSSP(VSS3OP),

.VDD3OP(VDD3OP));

vss2t_abb VSS2T_ANG(.CDL(CDL0),.VBB(PLL_VBB),

.VDD2OA(PLL_ANALOG_VDD),.VDD2IA(PLL_ANALOG_VDD),
.VSSTA(PLL_ANALOG_VSS));

pair50_abb_cip4 Inst1_pair_cip4(.PAD(RTC_XI),.Y(iRTC_XI),.VDD2PA(RTC_VDD),

.VBB(RTC_VSS),.VDD2OA(RTC_VDD),.VSSOA(RTC_VSS));

rtc [symbol] Inst_CIP4MAIN/A1_CIP4TOP/A1_MAINTOP/A0_RTC(.PCLK(

[symbol]

Inst_CIP4MAIN/A1_CIP4TOP/A1_MAINTOP/PRESETn),.PENABLE( [symbol]
Inst_CIP4MAIN/A1_CIP4TOP/CLK_RTC), .RTCXTAL1(oRTC_XO),.TMS( [symbol]
Inst_CIP4MAIN/A1_CIP4TOP/n11751),.SCAN_IN(in XDCK3),
.SCAN_EN( [symbol] Inst_CIP4MAIN/A1_CIP4TOP/A1_MAINTOP/n11752),
.SCAN_OUT( [symbol] Inst_CIP4MAIN/A1_CIP4TOP/A1_MAINTOP/RTC_SCAN_OUT),
.VDD3(RTC_VDD), .VDD(VDD2I),.VSS(RTC_VSS));

pll2013x [symbol] Inst_CIP4MAIN/A2_PLLCON/Inst_PLL(.FIN(CLK_SYS), .PWRDN(PLL_VSS), P({

[symbol]

Inst_CIP4MAIN/PLL_P_5A, [symbol] Inst_CIP4MAIN/PLL_P_4A, [symbol]
Inst_CIP4MAIN/PLL_P_3A, [symbol] Inst_CIP4MAIN/PLL_P_2A, [symbol]
Inst_CIP4MAIN/PLL_P_1A, [symbol] Inst_CIP4MAIN/PLL_P_0A}), .M({ [symbol]
Inst_CIP4MAIN/PLL_M_1A, [symbol] Inst_CIP4MAIN/PLL_M_0A}),.S({ [symbol]
Inst_CIP4MAIN/PLL_S_1A, [symbol] Inst_CIP4MAIN/PLL_S_0A}),.FILTER(oFILTER),
.FOUT( [symbol] Inst_CIP4MAIN/A2_PLLCON/CLK_PLL),.VDD25A1(PLL_ANALOG_ADD),
.VDD25A2(PLL_VDD),.VSS25A1(PLL_ANALOG_VSS),.VSS25A2(PLL_VSS),
.VBBA(PLL_VBB));

nr2d2b [symbol] Inst_CIP4MAIN/A2_PLLCON/U377(.A(

[symbol]

Inst_CIP4MAIN/A2_PLLCON/PMS_UPDATE2dly),.B( [symbol]
Inst_CIP4MAIN/A2_PLLCON/n921).Y( [symbol] Inst_CIP4MAIN/A2_PLLCON/n841),.VDD(
VDD2I), .VSS(VSS2I));

endmodule

As described above, a plurality of power sources are assigned to each logic element in the final net-list for designing the integrated circuit device 101.

By including a plurality of power sources in the final net-list to apply a separate power to each logic element, improvement in placing and routing, and layout verification can be achieved. In addition, a layout of a block which needs separate power in the integrated circuit device 101 can be correctly verified. Further, the error rate of the integrated circuit device 101 in the layout verification can be reduced.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

While this invention has been particularly described with reference to preferred embodiments thereof, it will be understood by those skilled in the art that various changes in form and details may be made therein without departing from the spirit and scope of the invention as defined by the appended claims and equivalents thereof.

What is claimed is:

1. A method for generating a net-list for designing an integrated circuit device, the method comprising:
(a) generating a pin template file by laying out logic elements included in an input/output unit of the integrated circuit device;
(b) generating a pin file by assigning a serial number to each of the logic elements and setting power names necessary for operating the logic elements, and generating a power inform template file by grouping an internal circuit of the integrated circuit device by a unit of power;
(c) generating a power inform file by combining the pin file with the power inform template file and arranging power information which is separately applied to each logic element included in the grouped internal circuit;
(d) generating a final power inform file by assigning correct power names to power ports to which power applied thereto is not defined; and
(e) completing a final net-list by combining core-related information of the integrated circuit device with the final power inform file.

2. The method of claim 1, further comprising selecting the logic elements for performing functions of the integrated circuit device and generating an initial net-list from the logic elements.

3. The method of claim 2, wherein step (a) further includes generating the pin template file by converting the initial net-list by a conversion program.

4. The method of claim 3, wherein the conversion program is cubicware.

5. The method of claim 1, wherein step (b) further includes assigning at least one power pad of the input/output device to each power group.

6. The method of claim 1, wherein step (d) further includes generating a question if no power port is assigned.

7. A method for generating a net-list for designing an integrate circuit device, the method comprising:
(a) generating an initial net-list in which power definitions are not included;
(b) converting the initial net-list into a pin template file in which logic elements included in an input/output unit of the integrated circuit device are laid out by using a conversion program;
(c) generating a pin file by editing the pin template file to assign a serial number to each of the logic elements and setting power names necessary for operating the logic elements, and generating a power inform template file by grouping an internal circuit of the integrated circuit device by a unit of power;
(d) generating a power inform file in which power information, which is separately applied to each logic element included in the grouped internal circuit, is arranged from the pin file and the power inform template file by using the conversion program;
(e) generating a final power inform file by editing the power inform file and assigning correct power names to power ports, to which power applied thereto is not defined, in the power inform file; and
(f) generating a final net-list including core-related information of the integrated circuit device in the final power inform file by using the conversion program.

8. The method of claim 7, wherein the conversion program is cubicware.

9. The method of claim 7, wherein step (c) further includes assigning at least one power pad of the input/output device to each power group.

10. The method of claim 7, wherein step (e) further includes generating a question if no power port is assigned.

11. A program storage device readable by machine, tangibly embodying a program of instructions executable by the machine to perform method steps for generating a net-list for designing an integrated circuit device, the method steps comprising:
(a) generating a pin template file by laying out logic elements included in an input/output unit of the integrated circuit device;
(b) generating a pin file by assigning a serial number to each of the logic elements and setting power names necessary for operating the logic elements, and generating a power inform template file by grouping an internal circuit of the integrated circuit device by a unit of power;
(c) generating a power inform file by combining the pin file with the power inform template file and arranging power information which is separately applied to each logic element included in the grouped internal circuit;
(d) generating a final power inform file by assigning correct power names to power ports to which power applied thereto is not defined; and
(e) completing a final net-list by combining core-related information of the integrated circuit device with the final power inform file.

12. The program storage device of claim 11, further comprising selecting the logic elements for performing functions of the integrated circuit device and generating an initial net-list from the logic elements.

13. The program storage device of claim 12, wherein step (a) further includes generating the pin template file by converting the initial net-list by a conversion program.

14. The program storage device of claim 13, wherein the conversion program is cubicware.

15. The program storage device of claim 11, wherein step (b) further includes assigning at least one power pad of the input/output device to each power group.

16. The program storage device of claim 11, wherein step (d) further includes generating a question if no power port is assigned.
